(19) United States
(12) Patent Application Publication
(10) Pub. No.: US 2005/0119019 A1
(43) Pub. Date: Jun. 2, 2005

(54) Method for searching for SMS message in a mobile terminal

(75) Inventor: Hye-Rang Jang, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/901,681

(22) Filed: Jul. 29, 2004

(30) Foreign Application Priority Data
Dec. 2, 2003 (KR) 2003-86939

(51) Int. Cl. H04Q 7/20

(52) U.S. Cl. 455/466; 455/412.1; 455/414.1

(57) ABSTRACT

A method is provided to effectively allow a mobile terminal's user to search for a desired SMS message in a list of received SMS messages. The list of received SMS messages is displayed on a display unit, and a plurality of search method options are provided to allow the user to search for an SMS message according to a plurality of search conditions. The search method options may be based on user data, a callback number and an origination address, respectively. If the user selects one of the search method options, a search condition window corresponding to the selected search method option is displayed on the display unit. The user inputs a search condition for searching for the desired SMS message via the displayed search condition window. The terminal's controller searches for an SMS message corresponding to the input search condition, and displays the retrieved SMS message on a display unit.

### PRIORITY

This application claims priority to an application entitled “METHOD FOR SEARCHING FOR SMS MESSAGE IN MOBILE TERMINAL”, filed in the Korean Intellectual Property Office on Dec. 2, 2003 and assigned Serial No. 2003-86939, the contents of which are incorporated herein by reference.

### BACKGROUND OF THE INVENTION

1. Field of the Invention

The present invention relates to a mobile terminal, and more particularly to a method for searching for a desired short message service (SMS) message among a plurality of SMS messages in a mobile terminal.

2. Description of the Related Art

A Short Message Service (SMS) is a service allowing mobile terminal users to exchange short messages composed of about 40 characters without the use of an additional device. As use of mobile terminals has rapidly increased, the number of people using the SMS service has also rapidly increased. Since the SMS service can deliver a message at almost the same time as when the message is sent, via other means, e.g., email, the SMS service has already been firmly established as a communication means. The SMS service generally provides a function of transmitting a message and a callback number between mobile terminals. The SMS service also allows terminal users to receive weather forecasts, news and stock information and the like. Also, the SMS allows the users to search for various information and select only required information from the searched requests. The SMS service allows terminal users to send or receive emails via the Internet or PC communications and also to use services for searching for various information required in their daily activities. The SMS service further provides information in an interactive manner for convenience of users, making it easy for anyone to use the service. Thus, the SMS service is increasingly used not only by young people but also by middleaged and older people who are unskilled in using online information.

The SMS service is provided in such a manner that mobile terminal users send and receive short text messages in a mobile communication system including a base station, a mobile switching center, a home location register and an SMS center. The SMS messages may be transmitted and received between mobile terminals and also between mobile terminals and information servers of service providers that provide a variety of information.

Mobile terminal users effectively use the SMS messages as information delivery means when they are in situations where they cannot perform voice communication or when a called party's terminal is powered off. Young people particularly enjoy producing various types of text emoticons according to their unique individualities, to exchange them with friends via the SMS service.

To allow a user to check received SMS messages, a mobile terminal displays the received messages on its screen, generally by arranging the messages according to their arrival times such that the most recently arrived message is preferentially displayed. The received SMS messages include their message center times, and are stored in a memory of the terminal according to their arrival times. A conventional storage format of the SMS messages is shown in FIG. 1a. This figure illustrates a conventional memory map structure in which received SMS messages are stored. As shown in FIG. 1a, the received SMS messages are stored sequentially in the order in which they arrived.

When the user presses a key to check received SMS messages that have been stored as shown in FIG. 1a, the messages are displayed on the screen as shown in FIG. 1b. FIG. 1b is a conventional screenshot of a list of received SMS messages displayed on the screen. The mobile terminal displays, the list of received SMS messages on the screen arranged according to their arrival times as shown in FIG. 1b.

The user checks received SMS messages by viewing the received SMS message list displayed in the manner described above. In other words, referring to part of user data, a callback number, a caller name corresponding to the callback number or the like, displayed in the received SMS message list, the user can select a desired message and view the body of the selected message. However, this SMS message search method is convenient only when a small number of received SMS messages are displayed in the received SMS message list.

As the rate at which users exchange SMS messages increases, the number of SMS messages stored in mobile terminals increases. This trend has led to the introduction of a special rate system focusing on the SMS service in which users can exchange several hundreds of messages every month. Some young people produce emoticons composed of various types of symbols or characters according to their unique individualities, and exchange more than several tens of SMS messages a day. If several tens of SMS messages are received, the user must check the received SMS message list while scrolling it in order to find and view a desired SMS message.

As described above, in the prior art, the mobile terminal's user must check the list of received SMS messages, which are arranged according to their arrival times, one by one to find a desired SMS message. This conventional SMS message check method, which is performed with reference to the SMS message list, causes inconvenience to the users in searching for a required SMS message with the help of increased storage capacity for SMS messages, if more than several tens of SMS messages have been received.

In addition, the user must press a corresponding key a large number of times to find a desired SMS message containing a specific word or a specific callback number among the listed SMS messages.

### SUMMARY OF THE INVENTION

Therefore, the present invention has been made in view of the above problem, and it is an object of the present invention to provide a method for searching for an SMS message in a mobile terminal, wherein the terminal includes a condition based search function to allow a user to effectively search for a desired SMS message, and displaying SMS messages retrieved according to an input search condition in order based on a predetermined rule.

In accordance with the present invention, the above and other objects can be accomplished by the provision of a method for searching for an SMS message in a mobile terminal, comprising the steps of a) displaying a search condition window corresponding to a search method option selected by a user from among at least one search method option for searching for an SMS message; b) receiving data for searching for a desired SMS message, said data being inputted as a search condition by the user via the search condition window; c) searching for the desired SMS message stored in a memory according to the input search condition; and d) displaying the desired SMS message, if searching at said step c) was successful.

### BRIEF DESCRIPTION OF THE DRAWINGS

The above and other objects, features and other advantages of the present invention will be more clearly understood from the following detailed description taken in conjunction with the accompanying drawings, in which:

FIG. 1a is a diagram illustrating a conventional memory map structure in which received SMS messages are stored;

FIG. 1b is a conventional screenshot of a list of received SMS messages displayed on the screen;

FIG. 2 is a block diagram showing the configuration of a general mobile communication system for providing an SMS service;

FIG. 3 is a block diagram showing the configuration of a received SMS message received according to an embodiment of the present invention;

FIG. 4 is a block diagram showing the internal configuration of a mobile terminal that provides a function of searching for an SMS message according to the present invention;

FIG. 5 is a flow chart showing a method for searching for an SMS message according to the embodiment of the present invention;

FIG. 6 is a flow chart showing a detailed example of the method for searching for the SMS message when search method options are provided according to the embodiment of the present invention;

FIG. 7 is a block diagram illustrating an example of a memory map in which received SMS messages are stored according to the embodiment of the present invention;

FIGS. 8a and 8b are a screenshot of search method options for searching for an SMS message according to the embodiment of the present invention;

FIGS. 9a to 9c are screenshots of search method options, a pop-up window, and an SMS message or messages retrieved based on an input search condition, respectively, when a search method option based on user data is selected;

FIGS. 10a to 10c are screenshots of search method options, a pop-up window, and an SMS message or messages retrieved based on an input search condition, respectively, when a search method option based on a call number is selected; and

FIGS. 11a to 11c are screenshots of search method options, a pop-up window, and an SMS message or messages retrieved based on an input search condition, respectively, when a search method option based on an origination address is selected.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

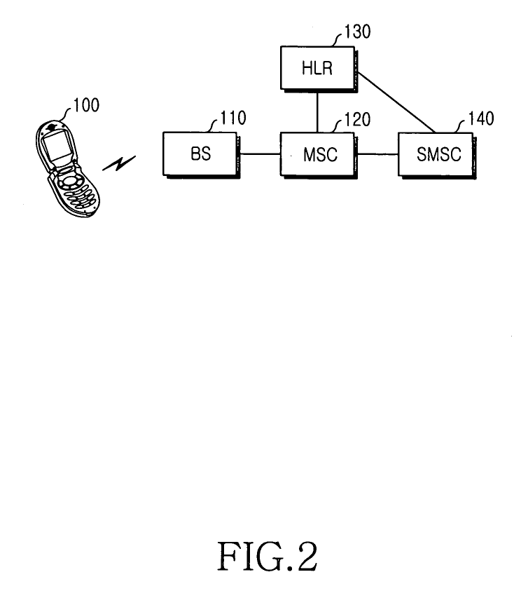

FIG. 2 is a block diagram showing the configuration of a general mobile communication system for providing a short message system (SMS) service. As shown in this figure, the mobile communication system includes a mobile terminal 100, a Base Station (BS) 110, a Mobile Switching Center (MSC) 120, a Home Location Register (HLR) 130 and a Short Message Service Center (SMSC) 140.

The base station 110 performs communication with the mobile terminal 100 in a radio zone, controls wireless and wired links, and also performs handoff process for maintaining communication continuity even when a user is in motion. The MSC 120 works together with other MSCs over a network to handle transmission/reception requests from the mobile terminal 100, and sends a request to the HLR 130 to inquire about a user of the mobile terminal 100. The HLR 130 is a midrange computer that mainly serves to manage mobile terminal users. The HLR 130 includes stored location information of the mobile terminal 100 and user information, and allows assignment of routes for incoming calls.

As an independent node, the SMSC 140 is connected to the HLR 130 and the MSC 120 and serves to locate the mobile terminal 100 and then to transfer an SMS message to the terminal's user. When a receiving terminal 100 cannot receive an SMS message, the SMSC 140 stores the SMS message to be transmitted to the receiving mobile terminal 100 for a predetermined period of time, and then forwards the stored SMS message to the receiving terminal 100.

A description will now be given of how an SMS message is transmitted in the mobile communication system that provides the SMS service as described above. A transmitting mobile terminal 100 or an information provider transmits an SMS message designated to be sent to a receiving mobile terminal and a phone number (i.e., a called number) of the receiving mobile terminal. Then, the SMS message and the called number are transmitted and stored in a message queue of the SMSC 140 via the base station 110, the MSC 120 and the like. At this time, a message indicating whether the SMS message has been normally transmitted to the SMSC 140 is transmitted to the transmitting mobile terminal 100. The SMSC 140 transmits the SMS message to the receiving mobile terminal, which corresponds to the called number received together with the SMS message. This transmission lasts for a predetermined period of time until the SMSC 140 receives a receipt response message from the receiving mobile terminal. The SMSC 140 deletes the SMS message stored in the message queue and terminates the SMS message transmission if it receives the receipt response message or if it does not receive the receipt response message for a predetermined period of time.

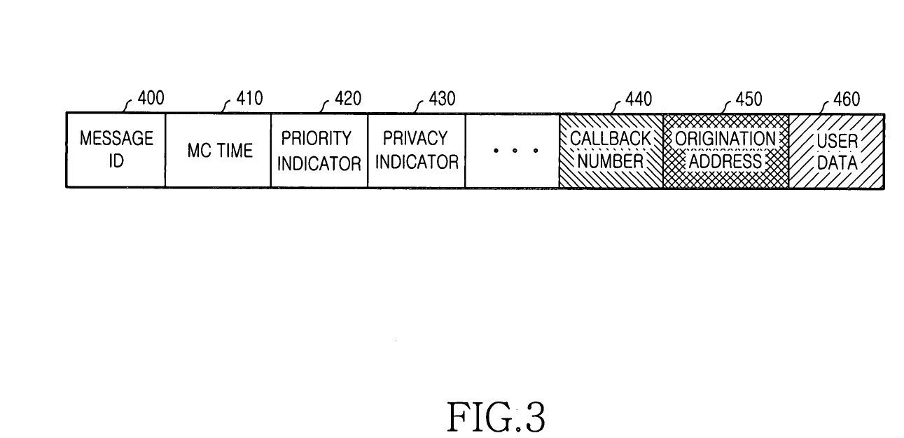

A description will now be given of the configuration of fields of an SMS message according to an SMS message communication protocol in the mobile communication system that provides the SMS service as described above. FIG. 3 is a diagram showing an exemplary format of an SMS message transmitted and received between the mobile terminal 100 and the SMSC 140, according to an embodiment of the present invention.

As shown in FIG. 3, one data frame of an SMS message generally includes a message identifier field 400 for message identification, a Message Center (MC) time stamp field 410 indicating time when the SMS message is transmitted from the SMSC, a priority indicator field 420 indicating priority level of the SMS message, a privacy indicator field 430 indicating whether the SMS message is confidential, a callback number field 440, an origination address field 450, a user data field 460, and various other fields required to transmit and receive the SMS message. This SMS message field format complies with the IS-637A protocol.

The following description of the embodiments of the present invention will be given focusing on the callback number field 440, the origination address field 450 and the user data field 460. The callback number field 440, which is applied to the present invention, includes data editable by the user, such as a number or a desired callback number input by the user. The origination address field 450 includes sender information, for example a unique phone number of a transmitting mobile terminal or a unique address of a website that provides an SMS service. The user data field 460 generally contains actual data that a sender desires to deliver to a recipient via an SMS message, and it is generally 80 bytes in size.

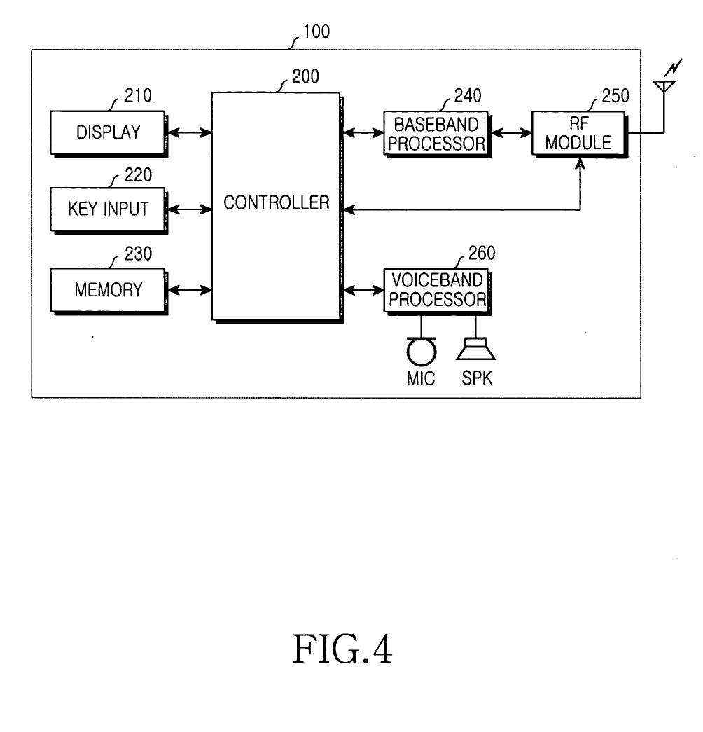

A description will now be given of how internal elements of a mobile terminal operate to handle an SMS message received by the mobile terminal, with reference to FIG. 4. FIG. 4 is a block diagram showing the internal configuration of a mobile terminal that provides a function of searching for an SMS message according to the present invention. As shown in this figure, the mobile terminal includes a controller 200, a display unit 210, a key input unit 220, a memory 230, a baseband processor 240, a RF module 250 and a voiceband signal processor 260. The controller 200 controls the overall operation of the mobile terminal 100, and additionally performs the SMS message search function according to the present invention, as described below. A description of processing and control of the controller 200 for conventional phone and data communication or wireless Internet connection will be omitted.

When the mobile terminal 100 receives an SMS message, the controller 200 analyzes contents of the received SMS message and processes data of each field of the received SMS message. The controller 200 controls elements for receiving and handling SMS messages in the mobile terminal 100. The controller 200 stores the received SMS messages in the memory 230. When the user selects a menu for checking received SMS messages, the controller 200 activates a received message mode, and lists the SMS messages stored in the memory 230 in the order of their received times, and then displays the SMS message list on the display unit 210.

If the user presses a message search menu key for searching for a desired SMS message, after the listed SMS messages are displayed in the order of their received times according to the embodiment of the present invention, the controller 200 displays search method options on the display unit 210. If the user selects one of the search method options, the controller 200 displays a corresponding search condition window for searching for the desired SMS message. The controller 200 searches for an SMS message corresponding to an input search condition among the SMS messages stored in the memory 230. The controller 200 determines whether an SMS message corresponding to the input search condition exists in the memory 230. If an SMS message corresponding to the input search condition exists, the controller 200 displays the SMS message on the display 210. In other words, the controller 200 analyzes fields, corresponding to the selected search method option, of the stored SMS messages, based on specific data input by the user to the search condition window. The controller 200 then determines whether the specific data input to the search condition window exists in the fields corresponding to the selected search method option. In this manner, the controller 200 searches for SMS messages, which include the input specific data in the corresponding fields, among the stored SMS messages, lists the retrieved SMS messages, and then displays the listed SMS messages on the display unit 210.

Directed by the controller 200, the display unit 210 displays various information and received SMS messages. If the user presses the search menu selection key according to the embodiment of the present invention, the display unit 210 displays a pop-up search condition window on a screen. The display unit 210 displays a list of SMS messages retrieved, based on a search condition input by the user.

The key input unit 220 includes number keys and various other keys, and provides data input by the user to the controller 200. The memory 230, connected to the controller 200, includes a voice memory, a Random Access Memory (RAM), a Read Only Memory (ROM) and the like for storing a plurality of programs and information required to control operations of the mobile terminal 100. The memory 230 also stores received SMS messages.

The RF module 250 transmits and receives RF signals to and from the base station 110 through an antenna ANT. The RF module 250 converts received RF signals to Intermediate Frequency (IF) signals, and then outputs the IF signals to the baseband processor 240. The RF module 250 converts IF signals received from the baseband processor 240 to RF signals, and then transmits the RF signal through the antenna ANT. The baseband processor 240 is a Baseband Analog ASIC (BAA) that provides an interface between the controller 200 and the RF module 250. The baseband processor 240 converts a baseband digital signal received from the controller 200 to an analog IF signal and applies the analog IF signal to the RF module 250. The baseband processor 240 also converts an analog IF signal received from the RF module 250 to a baseband digital signal, and applies the baseband digital signal to the controller 200. The controller 200 is connected with the voiceband signal processor 260 to which a microphone MIC and a speaker SPK are connected. The voiceband signal processor 260 produces data corresponding to a voice signal received from the microphone MIC and outputs the data to the controller 200. The voice band signal processor 260 also outputs voice data received from the controller 200 after converting it to audible sound through the speaker SPK.

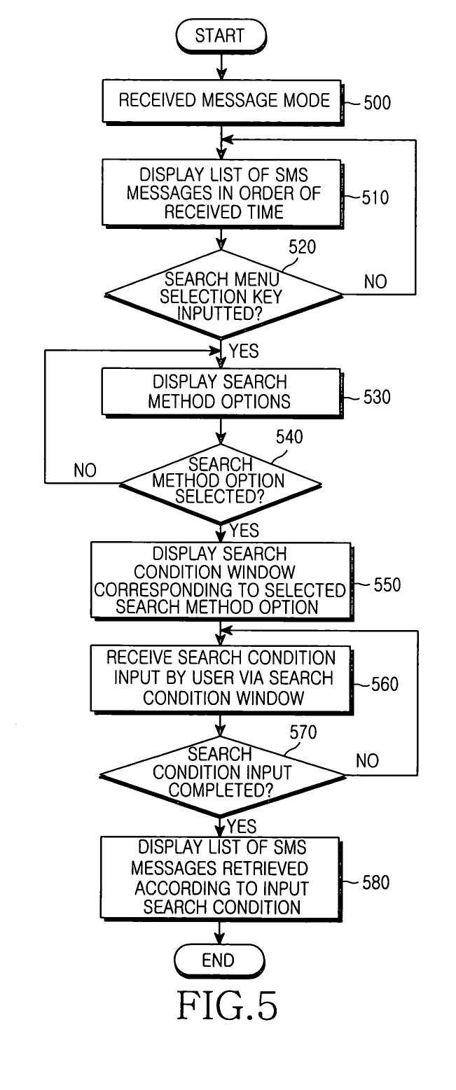

A description will now be given of how the mobile terminal is controlled to classify received SMS messages according to a search condition, with reference to FIG. 5. FIG. 5 is a flow chart showing a method for searching for an SMS message according to the embodiment of the present invention.

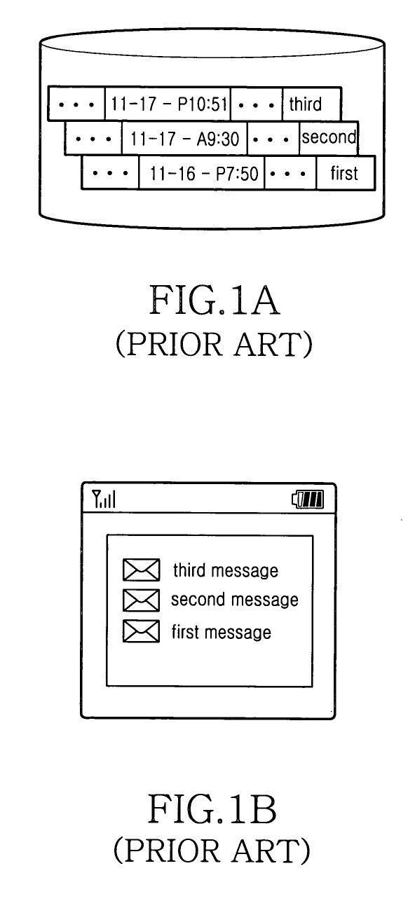

First, the controller 200 activates a received SMS message mode at step 500. If the user selects a key for checking received SMS messages, the controller 200 displays, in step 510, a list of SMS messages arranged according to their received times on the display unit 210. Here, the “received times” may indicate Message Center (MC) times of the SMS messages or may indicate times when the terminal actually receives delayed SMS messages. Under the control of the controller 200, SMS messages stored in the memory 230 are loaded to and displayed on the display unit 210 in the order of their received times. In other words, the controller 200 arranges the SMS messages sequentially in the order of their message center times that are included in their MC time stamp fields 410 (FIG. 3), and then displays the arranged SMS messages on the display unit 210. Generally, if the user selects a key for checking received SMS messages in the received SMS message mode, a list of SMS messages, which are arranged in the order in which they were received, is displayed on the screen as shown in FIG. 1b.

Further, the user can select a search menu that provides a condition-based search function according to the embodiment of the present invention. In other words, received SMS messages are displayed in the order of their received times, and a menu for searching for a desired SMS message among the received SMS messages is additionally provided according to the embodiment of the present invention. The search menu allows the user to retrieve the desired SMS message. After displaying the SMS messages arranged in the order of their received times at step 510, the controller 200 determines, in step 520, whether the user has pressed a key for selecting the search menu according to the embodiment of the present invention. If the user has not pressed the search menu selection key, the controller 200 continues to display the SMS messages listed according to their received times at step 510. On the other hand, if the user has pressed the search menu selection key, in step 530 the controller 200 displays search method options.

The search method options include a plurality of search methods respectively based on possible search conditions for searching for a desired SMS message. For example, the search method options may include search methods, respectively, based on a sender name, a sender number, user data, a callback number, an origination address and the like of the desired SMS message. At step 540, the controller 200 determines whether the user has selected one of the search method options. If the user has selected one of the search method options, the controller 200 displays, in step 550, a pop-up search condition window corresponding to the selected search method option. The controller 200 then receives, in step 560 a search condition input by the user according to the selected search method option. At step 570, the controller 200 determines whether the user has completely input the search condition. If the user has completely input the search condition, in step 580 the controller 200 retrieve SMS messages corresponding to the search condition from the memory and display a list of the retrieved SMS messages.

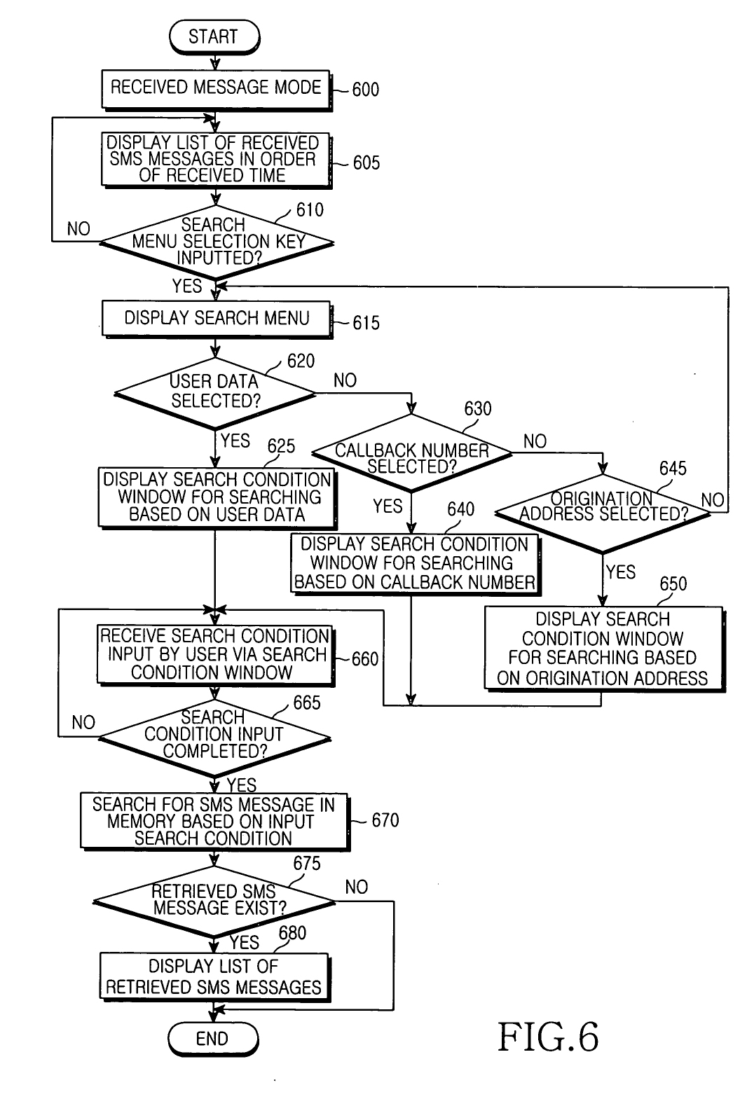

A detailed example of the method for searching for an SMS message when search method options respectively based on user data, a callback number and an origination address are provided will now be described with reference to the flow chart of FIG. 6 and FIGS. 8-11.

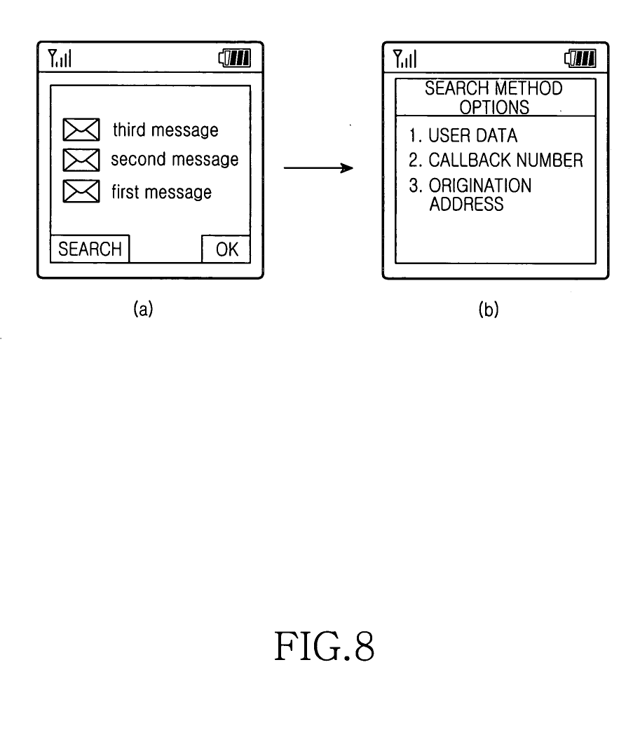

First, at step 600, the controller 200 activates a received SMS message mode, and then at step 605 displays a list of SMS messages arranged according to their received times. A search menu according to the embodiment of the present invention may be additionally displayed as shown in FIG. 8a while the list of SMS messages arranged according their received times are displayed. Then, at step 610, the controller 200 determines whether the user has pressed a soft key corresponding to the search menu according to the embodiment of the present invention. If the user has pressed the soft key corresponding to the search menu, at step 615 the controller 200 displays search method options as shown in FIG. 8b.

As shown in FIG. 8b, a first search method option “1. User Data”, a second search method option “2. Callback Number” and a third search method option “3. Origination Address” are provided as search method options according to the embodiment of the present invention.

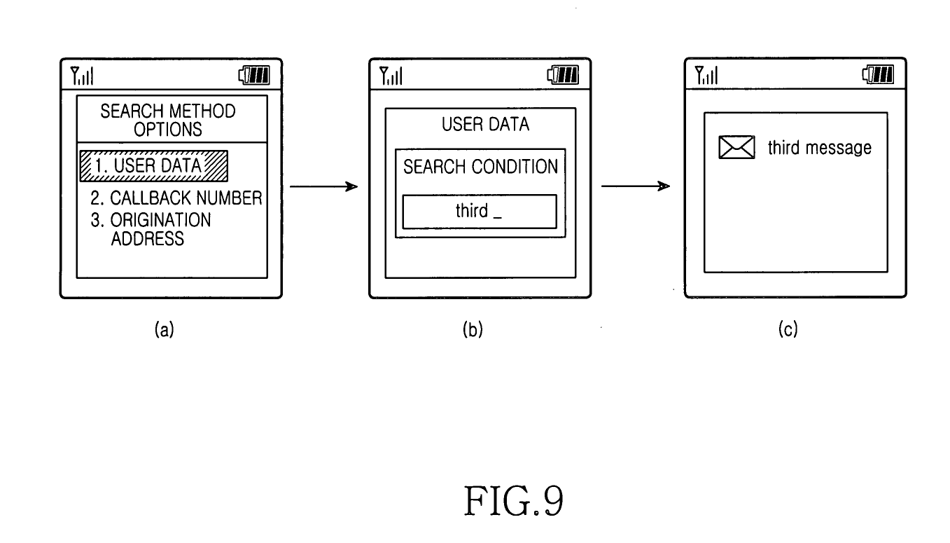

Returning to FIG. 6, after displaying the search method options as described above in response to the press of the search menu selection key, the controller 200 determines, at step 620, whether the user has selected the first search method option based on the user data. If the user has selected the first search method option as shown in FIG. 9a, at step 625 the controller 200 displays a pop-up search condition window for searching for a desired SMS message based on its user data as shown in FIG. 9b.

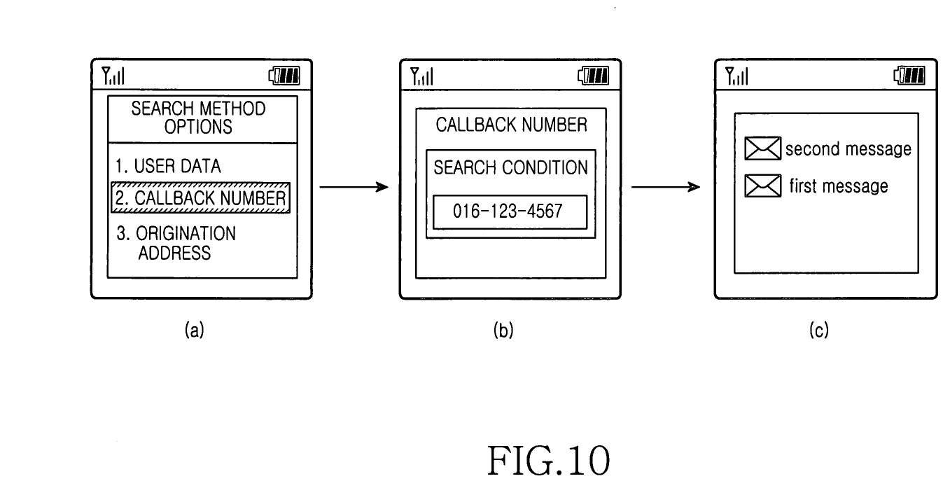

If the user has selected the second search method option as shown in FIG. 10a, the controller 200 detects, at step 630, that the user has selected the callback number based search method. Then, at step 640 the controller 200 display a pop-up search condition window for searching for a desired SMS message based on its callback number as shown in FIG. 10b.

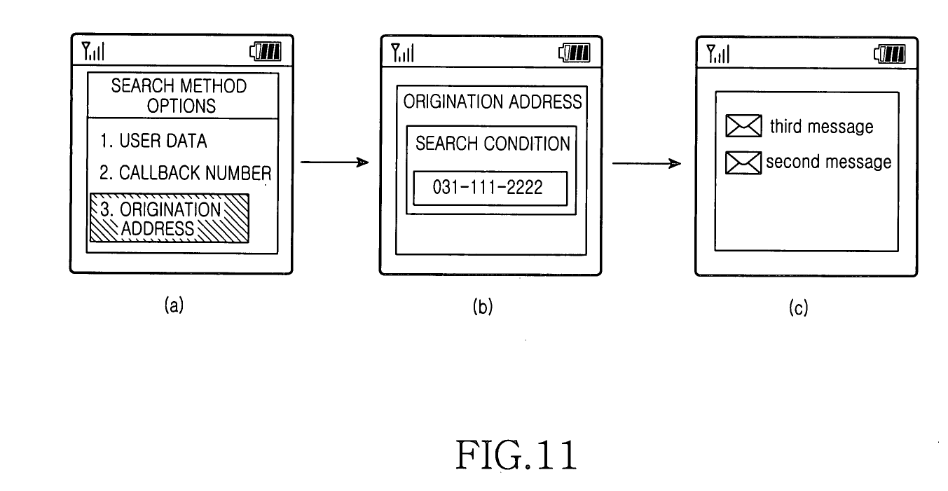

If the user has selected the third search method option as shown in FIG. 11a, the controller 200 detects, at step 645, that the user has selected the origination address based search method. Then, at step 650 the controller 200 display a pop-up search condition window for searching for a desired SMS message based on its origination address as shown in FIG. 11b.

If the user has selected one of the three search method options as described above, the controller 200 receives, at step 660, a search condition input by the user to a search condition window corresponding to the selected search method. The controller 200 then determines, at step 655, whether the user has completely input the search condition. If the user has completely input the search condition, the controller 200, at step 670, searches for SMS messages stored in the memory according to the input search condition. The controller 200 then determines, at step 675, whether an SMS message searched for according to the input search condition exists in the memory. If such an SMS message exists, at step 680 the controller 200 displays the retrieved SMS message or messages in the order based on a predetermined rule. This predetermined rule may be one of the order in which the SMS messages were received, an alphabetical or consonant-vowel order of the first letters (or characters) of the SMS messages, and numerical order of the callback numbers thereof. If origination addresses or callback numbers of the SMS messages include Roman letters, the SMS messages may also be arranged in alphabetical order.

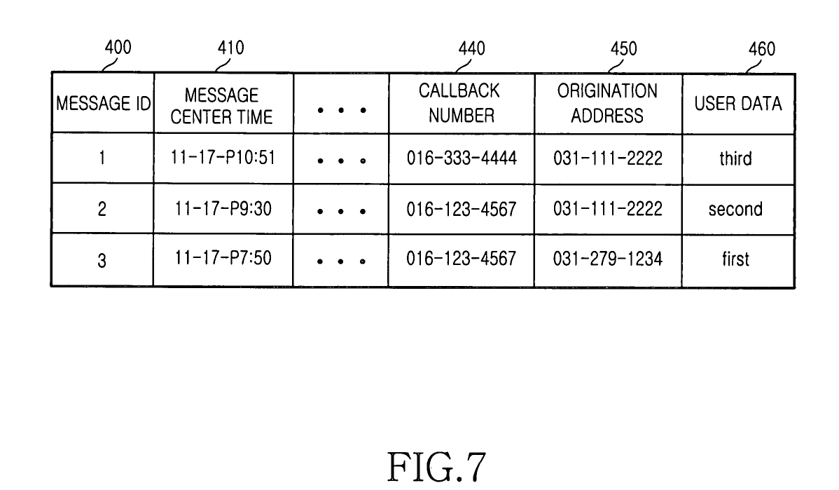

A detailed example of the method for searching for the SMS message according to the embodiment of the present invention will now be described with reference to FIGS. 7, 9, 10 and 11. FIG. 7 is a memory map diagram illustrating an example of a memory map in which received SMS messages are stored according to the embodiment of the present invention. FIGS. 9a to 11c are exemplary screenshots of search method options (FIGS. 9a, 10a and 11a), pop-up search condition windows displayed when one of the search method options has been selected (FIGS. 9b, 10b and 11b), and SMS messages retrieved based on input search conditions (FIGS. 9c, 10c and 11c).

First, we described the case where three SMS messages have been received sequentially as shown in FIG. 8a. The received SMS messages are stored in the memory in a format as shown in FIG. 7. As shown in FIG. 7, a message data frame corresponding to one of the three SMS messages, whose message ID 400 is 1, includes data “11-17-P10:51” in a message center time field 410, data “016-333-4444” in a callback number field 440, data “031-111-2222” in an origination address field 450, and data “third” in a user data field 460 corresponding to a message body.

As shown in FIG. 7, a message data frame corresponding to another one of the three SMS messages, whose message ID 400 is 2, includes data “11-17-P9:30” in a message center time field 410, data “016-123-4567” in a callback number field 440, data “031-111-2222” in an origination address field 450, and data “second” in a user data field 460 corresponding to a message body.

As shown in FIG. 7, a message data frame corresponding to the other one of the three SMS messages, whose message ID 400 is 3, includes data “11-17-P7:50” in a message center time field 410, data “016-123-4567” in a callback number field 440, data “031-279-1234” in an origination address field 450, and data “first” in a user data field 460 corresponding to a message body. The field configuration of the SMS messages stored in the memory is shown in FIG. 7 as described above.

First, if the user selects a received SMS message mode, three SMS messages are displayed sequentially in the order in which they were received as shown in FIG. 8a. In the case where the user desires to search for an SMS message, including a word “third” in user data of the message corresponding to a message body thereof, among the three listed SMS messages displayed on the screen, the user needs to press a soft key corresponding to a search menu as shown in FIG. 8a. If the user presses the soft key corresponding to the search menu, search method options are displayed on the screen as shown in FIG. 8b. The user moves a cursor to the first search method option “1. User Data” as shown in FIG. 9a using a navigation key. With the cursor positioned on the first search method option, the user presses a soft key for selecting the first search method option (i.e., a search method based on user data). If the user presses the soft key for selecting the search method based on user data, a corresponding search condition window is displayed on the screen as shown in FIG. 9b. If the user inputs a word “third” to the displayed search condition window, the controller 200 searches for an SMS message, including the word “third” in a data user field thereof, among the SMS messages stored in the memory as shown in FIG. 7. This search is performed according to an SMS protocol, and the reason why this search is possible is that the position of the data field is known in the SMS message fields. One SMS message including the word “third” exists as shown in FIG. 7, and thus the retrieved SMS message is displayed on the screen as shown in FIG. 9c. Here, if there are a plurality of retrieved SMS messages, they are displayed in alphabetical order or in consonant-vowel order of the first words of the messages.

In the case where the user desires to search for an SMS message, including a number “016-123-4567” in a callback number of the message, among the three listed SMS messages displayed on the screen, the user presses a key for selecting the search menu, so as to display the search method options on the screen as shown in FIG. 8b. The user moves the cursor to the second search method option “2. Callback Number” as shown in FIG. 10a using a navigation key. With the cursor positioned on the second search method option, the user presses a soft key for selecting the second search method option (i.e., a search method based on a callback number). If the user presses the soft key for selecting the search method based on the callback number, a corresponding search condition window is displayed on the screen as shown in FIG. 10b. The user can input “016-123-4567” as the entire callback number or input only “4567” as part thereof to the search condition window. The controller 200 searches for an SMS message corresponding to the input search condition in the memory. This search retrieves two SMS messages including the input search condition “016-123-4567” as shown in FIG. 7. A list of the two retrieved SMS messages is displayed on the screen as shown in FIG. 10c. Here, the retrieved SMS message list may be displayed on the screen with part of their user data as shown in FIG. 10c. According to the embodiment of the present invention, the retrieved SMS message list may also be displayed based on the search method option selected by the user. For example, the retrieved SMS message list may be displayed on the screen with part of the callback number (as the search condition) input by the user. In this case, the retrieved SMS messages are arranged in numerical order of their callback number.

In the case where the user desires to search for an SMS message, including “031-111-2222” in an origination address of the message, among the three listed SMS messages displayed on the screen, the user presses a key for selecting the search menu, so as to display the search method options on the screen as shown in FIG. 8b. The user moves the cursor to the third search method option “3. Origination Address” as shown in FIG. 11a using a navigation key. With the cursor positioned on the third search method option, the user presses a soft key for selecting the third search method option (i.e., a search method based on an origination address). If the user presses the soft key for selecting the search method based on the origination address, a corresponding search condition window is displayed on the screen as shown in FIG. 11b. The user can input “031-111-2222” as the entire origination address or input only “2222” as part thereof to the search condition window. The controller 200 searches for an SMS message corresponding to the input search condition in the memory. This search retrieves two SMS messages including the input search condition “031-111-2222” as shown in FIG. 7. A list of the two retrieved SMS messages is displayed on the screen as shown in FIG. 11c. The list of the two retrieved SMS messages may be displayed in alphabetic or numerical order of the origination address on the screen with part of the origination address.

As apparent from the above description, the present invention provides a method for searching for an SMS message in a mobile terminal, which has the following features and advantages. The terminal includes a function of searching for a desired SMS message among more than several tens of received SMS messages. The terminal also provides a plurality of search method options to allow the terminal's user to search for a desired SMS message in various ways. This method effectively decreases the time required to search for a desired SMS message among the received SMS messages, and also enables searching with only a small number of key inputs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for searching for a short message system (SMS) message in a plurality of SMS messages stored in a mobile terminal, comprising the steps of:
a) displaying a search condition window corresponding to a search method option selected by a user from among at least one search method option for searching for the SMS message;
b) receiving data for searching for the SMS message, said data being input as a search condition by the user via the search condition window;
c) searching for the SMS message stored in a memory according to the input search condition; and
d) displaying the SMS message searched at said step c).

2. The method according to claim 1, wherein said at least one search method option includes a search method option based on user data, a search method option based on a callback number, and a search method option based on an origination address.

3. The method according to claim 1, wherein the search condition window is displayed in the form of a pop-up window, and the user is allowed to input the full or part of a predetermined search key word for searching for the SMS message.

4. The method according to claim 1, wherein said step d) further includes the steps of:
d-1) searching for an SMS message in the memory, said SMS message including data corresponding to the input search condition in a field of the SMS message, said field corresponding to the selected search method option; and
d-2) displaying an SMS message searched at step d-1).

5. The method according to claim 1, wherein if a plurality of SMS messages are retrieved at said step c), said step d) further includes the step of displaying the plurality of retrieved SMS messages sequentially arranged based on a predetermined rule.

6. The method according to claim 5, wherein the predetermined rule is selected from one of an order in which the retrieved SMS messages were received, an alphabetical order of first words of the retrieved SMS messages, and a numerical order of callback numbers thereof.

7. A method for searching for a short message system (SMS) message in a plurality of SMS messages in a mobile terminal, comprising the steps of:
determining whether a user selects a search menu for searching for a desired SMS message based on a search condition;
displaying a search condition window corresponding to a selection of the search menu;
receiving a search condition input by the user via the search condition window; and
searching for the desired SMS message based on the input search condition, and displaying the searched desired SMS message.

8. The method according to claim 7, wherein said search condition includes at least one of a callback number and an origination address selected from the user data.
